(19) United States
(12) Patent Application Publication
(10) Pub. No.: US 2007/0281559 A1
(43) Pub. Date: Dec. 6, 2007

(54) Amphibious recreational vessel

(76) Inventors: Joseph Stanley, Falmouth, ME (US); Roger Whitney Long, Cape Elizabeth, ME (US)

Correspondence Address: CHRIS A. CASEIRO, VERRILL DANA, LLP, ONE PORTLAND SQUARE, PORTLAND, ME, 04112-0586, US

(21) Appl. No.: 11/443,498

(22) Filed: May 30, 2006

(51) Int. Cl. B60F 3/00; B63H 19/08

(52) U.S. Cl. 440/12.5

(57) ABSTRACT

A recreational vessel for carrying a plurality of passengers capable of movement on land and in water. The recreational vessel includes an upper section with passenger seating, and lower section having an engine, a transmission, a marine propulsion unit, and at least two sets of wheels joined by axles. The upper and lower sections are separated by a deck plate. The lower section forms a pod-free and watertight hull which is designed to maximize both the aerodynamic and hydrodynamic efficiency of the vessel. Located between the deck plate and the inner bottom surface of the hull is an engine, which is centered within the hull and is coupled to a transfer case. The transfer case is coupled to a first drive shaft and to a second drive shaft. The first drive shaft is connected to two axles to effect the rotation of the two axles. The second drive shaft is connected to and drives the marine propulsion unit. The vehicle further is equipped with a spring-loaded ladder.

### BACKGROUND OF THE INVENTION

1. Field of the Invention

The present invention relates to transportation devices. More particularly, the present invention relates to vessels that are capable of movement both on land and in water. Still more particularly, the present invention is related to amphibious recreational vessels.

2. Description of the Prior Art

Vehicles that may be both driven on land and navigated on water, or what are commonly referred to as amphibious vehicles, have been used by the United States military in its operations worldwide. Amphibious vehicles also have been used by civilians for recreational purposes. These amphibious recreational vehicles are routinely used to transport tourists as part of sightseeing tours over roadways and along waterways in some U.S. cities.

Present amphibious recreational vehicles, however, have significant flaws. For one, whether they are being operated on land or on water, they are highly fuel inefficient. Further, they are difficult and costly to maintain. Even further, they are not optimally designed to accommodate all passengers. Indeed, some passengers, including some elderly and physically challenged persons, find it difficult to embark and disembark these vehicles.

Some of these flaws are attributable to the fact that they are primarily floatable trucks. Specifically, present amphibious recreational vehicles may be thought of primarily as being terrain vehicles, and more specifically, trucks, which are modified for use in water. For this reason, these vehicles have body frames and drive trains that mimic those typically seen in trucks. For example, consider the amphibious vehicle described in U.S. Pat. No. 6,482,052 issued to Giljam. The drive train of the Giljam vehicle includes among other parts a truck engine, an ignition system, a transmission, a power splitting device, two drive shafts, and various control system components. A third drive shaft is included for operating a marine propulsion means which is located at the rear of the vehicle. Also included as part of the drive train is a radiator which must be proximate to the engine for proper engine functioning.

Much of the Giljam drive train resides in a large pod that extends concavely downward from the bottom of the vehicle's hull. Included in the pod is the engine, which is positioned at one end of the drive train. In this arrangement, the engine is not centrally located within the entire vehicle, but instead lies closer to the front of the vehicle than to its back. However, placing the engine, which is substantially heavy, aft of center causes the weight of the entire vehicle to be unevenly proportioned. To help compensate for this imbalance, the Giljam vehicle includes foam filled compartments, which are said to provide stability and buoyancy to the vehicle.

U.S. Pat. No. 6,575,796 issued to McDowell is another example of a vehicle having a truck-like drive train and body frame. The McDowell patent describes a drive train for an amphibious vehicle. Among its other parts, the McDowell drive train includes an engine which is connected to a transmission. The transmission also is connected to a transfer case, which is further connected to a gearbox. The gearbox also is connected to a first propeller drive shaft, which is further connected to a second propeller drive shaft, which is further connected to a propeller.

Like the Giljam engine, the McDowell engine is aft of center in the vehicle, and specifically is located near the extreme front end of the vehicle. Also like the Giljam vehicle, the bottom of the McDowell vehicle's hull is not flat or uniformly shaped, but instead extends downward at the area of the hull located between its front wheels and rear wheels, thereby effectively creating a pod-like structure in the hull. This pod-like structure houses several of the drive train components.

One of the limitations of these truck-like drive trains is that they have a number of parts, such as the radiator of Giljam and the gearbox of McDowell, that do little or nothing to improve the operation or efficiency of the vehicle, particularly when in the water. Therefore, these drive trains could be redesigned such as to not include these unneeded parts without reducing the utility of the vehicle. Moreover, not having these unnecessary parts actually would provide two advantages. First, having fewer parts would reduce the probability that the vehicle will breakdown due to failure of one of these parts. Second, eliminating unneeded parts would cause the weight of the vehicle to be reduced, which in turn would cause the fuel efficiency of the vehicle to be increased.

Other aspects of prior amphibious vehicles, such as those of McDowell and Giljam, also contribute to these performance problems. For example, consider the pod of each vehicle, which, by causing the drag coefficient of the vehicle to be increased while the vehicle is being operated both on land and on water, effectively reduces both the aerodynamic and hydrodynamic properties of the vehicle. Because even slight increases in a vehicle's drag coefficient can cause a substantial reduction in fuel efficiency, vehicles like those of McDowell and Giljam, whose pod effects a great increase in the drag coefficient, are therefore not optimally fuel efficient.

As another example, consider the foam filled compartments of Giljam, which Giljam states are required to negate the imbalance that positioning the engine aft of center has on the weight distribution of the vehicle. The foam filled compartments, which would be wholly unnecessary to a vehicle having a well-balanced weight distribution make the vehicle more difficult to maintain. This is true because their foam occasionally must be replaced, and because they can obscure other parts of the vehicle which occasionally must be repaired.

Yet another drawback to present amphibious recreational vehicles, and one which is not related to body frame design or to nature of the drive shaft, is that some passengers find them difficult to embark and disembark. Indeed, some elderly and handicapped persons, for example, have trouble embarking and disembarking these vehicles.

What is needed therefore is an amphibious vehicle which is easy and inexpensive to maintain, has an improved mileage-to-fuel consumption ratio, and is easy for all passengers to enter and exit.

### SUMMARY OF THE INVENTION

It is an object of the present invention to provide an amphibious recreational vessel, which specifically is a vessel capable of movement on land and in water.

It also is an object of the present invention to provide an amphibious recreational vessel that has all of the advantages of a water vessel, including those provided by body design and part composition, and which does not have the limitations that accompany amphibious vehicles having a truck-like body frame and drive train.

Further, it is an object of the present invention to provide an amphibious recreational vessel that is both easy and inexpensive to maintain. Toward this goal, the amphibious recreational vessel of the present invention includes a reduced number of parts. The invention therefore has fewer parts that need to be maintained, and which otherwise would inconveniently obscure access to other parts of the invention that are in need of repair.

It is another object of the present invention to provide an amphibious recreational vessel that is optimally designed to maximize the vessel's mileage-to-fuel consumption ratio when the vessel move on land and in water. Toward this end, the frame of the vessel, including its hull, is optimally designed to be both aerodynamic and hydrodynamic. Additionally, since the vessel of the present invention has fewer drive train components than do truck-like amphibious vehicles, the weight of its drive train is minimized, which in turn helps to maximize the vessel's mileage-to-fuel consumption ratio on land.

It is yet another object of the present invention to provide an amphibious recreational vessel that is optimally designed to accommodate passengers of all physical ability. The present invention therefore is equipped with a ladder, which may be spring-loaded, and which may be used by all passengers, including the physically challenged, for both entering and exiting the vessel.

The details of one or more examples related to the invention are set forth in the accompanying drawings and the description below. Other features, objects, and advantages of the invention will be apparent from the description and the drawings.

### BRIEF DESCRIPTION OF THE DRAWINGS

FIG. 1 is a first elevation view of the starboard side of the vessel of the present invention.

FIG. 2 is a second elevation view of the starboard side of the vessel of the present invention with a cut out of the hull to show parts of the drive train.

FIG. 3 is an elevation view of the port side of the lower section and the components of the drive train of the vessel of the present invention.

FIG. 4 is a plan view of the lower section and the components of the drive train of the vessel of the present invention.

FIG. 5 is an elevation view of the front end of the vessel showing the ladder in a stowed position.

FIG. 6 is an elevation view of a portion of the front end of the vessel showing the ladder in a deployed position.

FIG. 7 is an elevation view of a portion of the front end of the vessel showing the bow thruster and front bumper combination.

FIG. 8 is a plan view of the front end of the vessel showing the bow thruster and front bumper extending the width of the vessel at the bow.

### DETAILED DESCRIPTION OF THE PREFERRED EMBODIMENT

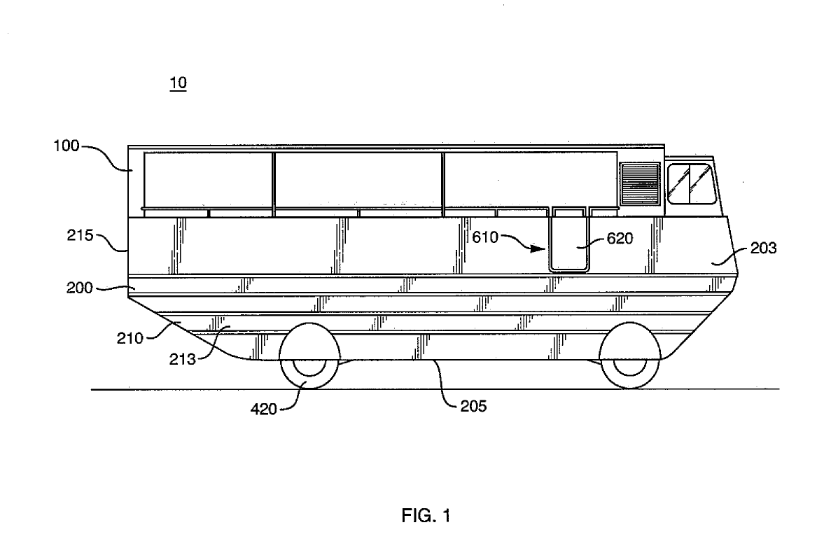

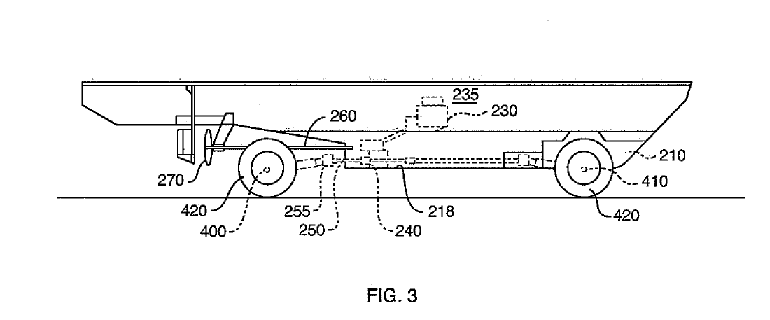

The present invention is a recreational vessel capable of movement on land and in water. The present invention, therefore, is an amphibious recreational vessel. Referring to FIGS. 1-4, the vessel 10 includes an upper section 100, having a deck surface 105, and a lower section 200. The upper section 100 and the lower section 200 are separated by a deck plate 110. The deck plate 110 contains a watertight hatch 120 which enables the lower section 200 to be accessed from the upper section 100.

In a preferred embodiment of the present invention, shown in FIG. 1, the entire length of outer bottommost surface 205 of the lower section 200, which specifically is the surface of the vehicle 10 most distal to the upper section 100, is flat. In an alternative embodiment, which is not shown, the entire outer bottom surface 205 extends concavely in a direction away from the upper section 100. Further, the lower section 200 does not contain a pod or any pod-like structure in any embodiment of the present invention. Because it does not have a pod or a pod-like structure, the outer bottommost surface 205 of the lower section 200 is able to set close to the ground when the vessel 10 is on land.

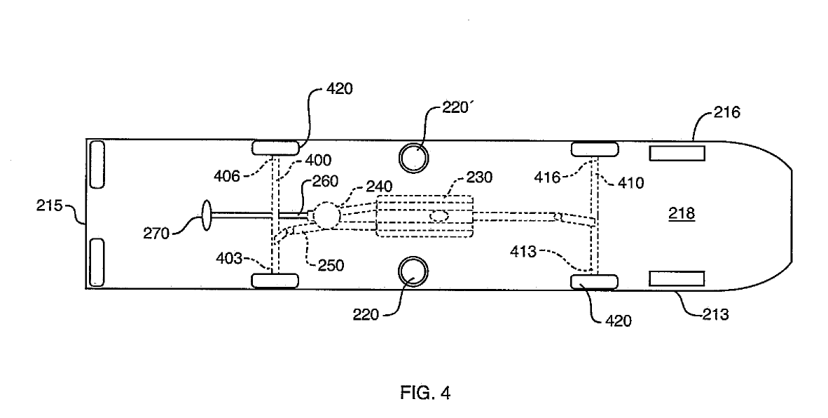

Further, the lower section 200 forms a hull 210. The hull 210 has both a starboard side 213, which is shown in FIG. 1, and a port side 216, which is shown in FIG. 4. Located both at the inside bottom surface 218 of the hull 210 and within the hull 210 are a first bilge tank 220 and a second bilge tank 220′. Specifically, the first bilge tank 220 is located on the starboard side 213 of the inner bottom surface 218 of the hull 210, and the second bilge tank 220′ is located on the port side 216 of the inner bottom surface 218 of the hull 210.

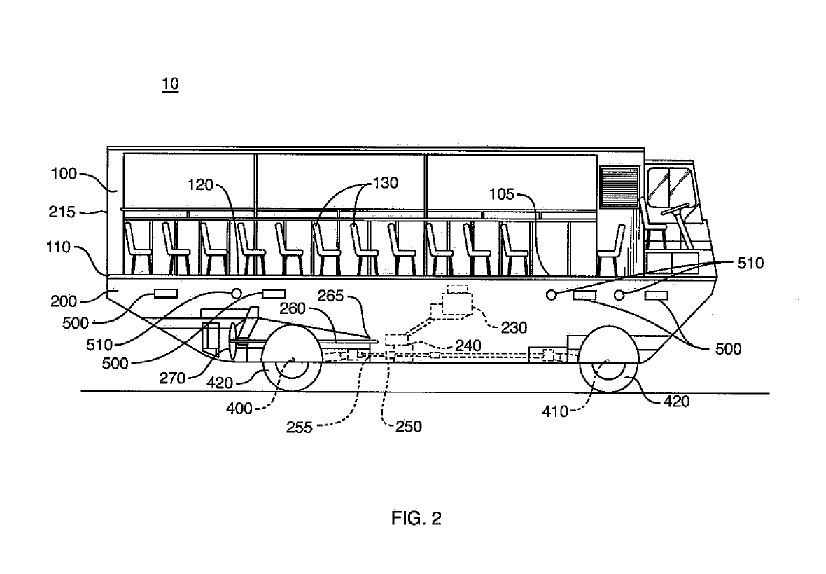

Referring to FIG. 2, included between the first section 100 and the bilge tanks 220 and 220′ is an engine 230, which is essentially centered between the bilge tanks 220 and 220′. The placement of the engine 230 to a central position 235 within the hull 210 of the vessel 10, and therefore within the vessel 10 itself, enhances vessel 10 stability. The engine 230 is coupled to a transfer case 240. The transfer case 240 is positioned at the inner bottom surface 218 of the hull 210 between the bilge tanks 220 and 220′. The transfer case 240 is further coupled to a first drive shaft 250 and a second drive shaft 260. The first drive shaft 250 passes through a first hole 255 of the hull 210 and is further coupled to a first axle 400 which is included as part of the lower section 200. The second drive shaft 260 passes through a second hole 265 of the hull 210 and is further coupled to a marine propulsion unit 270. The marine propulsion unit 270 may be, but is not limited to being, a propeller. The marine propulsion unit 270 also may include, but is not limited to including, a bow thruster. An exemplary bow thruster which may be used is the American Bow Thruster TRAC™ system, which is made available by Arcturus Marine Systems of Rohnert Park, Calif. A thruster is a propeller located at the front (bow) of a watercraft or rear (stern) of the watercraft. It is generally located at the lower sea-covered part of the watercraft. It is arranged to turn at right angles to the fore-and-aft line of the watercraft and thus provides transverse thrust as a maneuvering aid. The present invention contemplates the option to use a bow thruster in combination with a propeller, a stem thruster in combination with the propeller, or the combination of all three.

As shown in FIG. 4, also included as part of the lower section 200 is a second axle 410. Connected to each of a first end 403 of the first axle 400, a second end 406 of the first axle 400, a first end 413 of the second axle 410, and a second end 416 of the second axle 410 is a wheel 420. In this arrangement, each wheel 420 may be fully rotated in both a clockwise direction and a counterclockwise direction.

The vessel 10 is designed to be optimally safe. In addition to centrally placing the engine 230 within the vessel 10 for the purpose of giving the vessel 10 stability, the upper section 100 of the vessel 100 is watertight, such that water contained on the surface of the upper section 100 cannot pass the deck plate 110 to enter the lower section 200. Further, the vessel 10 may include a plurality of high air intake openings 500 and exhaust openings 510, which allow fresh air from outside the vessel 10 to be continuously exchanged with the air inside the lower section 200, which may contain, for example, exhaust fumes. In a preferred embodiment of the present invention, the high air intake openings 500 are National Advisory Committee for Aeronautics (NACA) ducts. The NACA duct or NACA scoop is a common form of low-drag intake design. When properly implemented, it allows fluid to be drawn into an internal duct, often for cooling purposes, with a minimal disturbance to the flow. See Frick, Charles W.; Davis, Wallace F.; Randall, Lauros M.; and Mossman, Emmet A.: An Experimental Investigation of NACA Submerged Duct Entrances NACA ACR 5120, 1945 for background information on the original NACA duct development. NACA ducts are preferred in regard to the vessel 10 because they shed water efficiently while the vessel 10 is moving on water. It is to be understood, however, that the high air intake openings 500 are not limited to being NACA ducts.

The vessel 10 may be used to transport a plurality of passengers. To facilitate passenger transportation, the vessel 10 may be include a plurality of seats 130, such as those shown in FIG. 2, which are connected to the deck surface 105 of the upper section 100.

Further facilitating passenger transportation is one or more spring-loaded ladders 600 which passengers may use to enter and exit the vessel 10. The one or more spring-loaded ladders 600 may be located on the port side 216, the starboard side 213, and/or the back end 215 of the vessel 10.

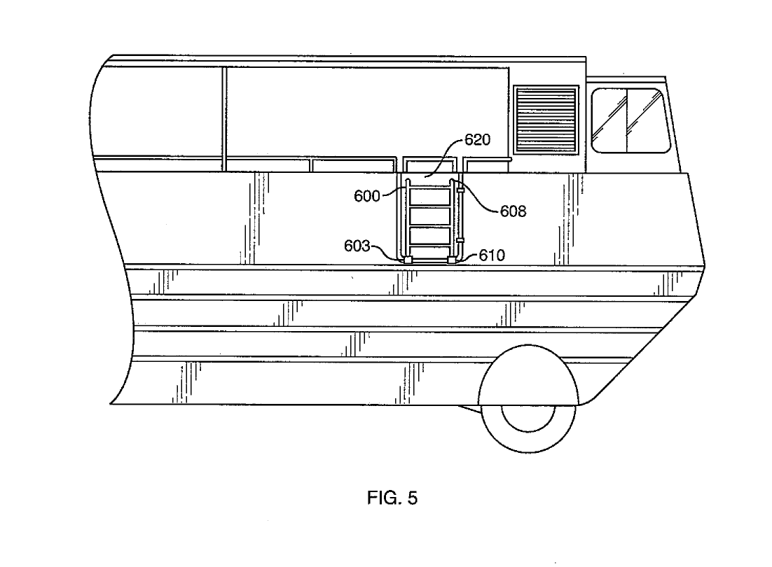

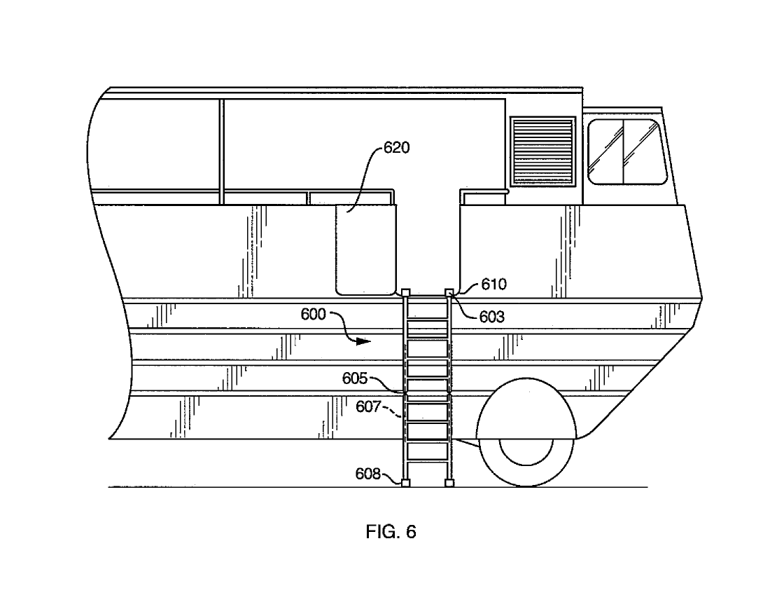

In a preferred embodiment of the vessel 10 of the present invention as shown in FIGS. 5-6, the vessel 10 has one spring-loaded ladder 600 having a first end 603. The first end 603 is connected to the vessel 10 at position 610 which is near door 620. The ladder 600 may be folded such that a second end 608 of the ladder 600 contacts, or nearly contacts, section 605 of the ladder 600, in what may be referred to as its “closed” arrangement. Specifically, section 605 may be any region of the ladder 600 between first end 603 and second end 608. Further, when the ladder is in the closed arrangement, the ladder 600 may be reversibly locked to prevent second end 608 from being substantially removed from contacting, or nearly contacting, section 605. It may be preferred to keep the ladder 600 locked in the closed position, for example, when the vessel 10 is in motion.

When locked in the closed position, second end 608 of the ladder 600 may be unlocked by an individual. When unlocked, second end 608 may be removed from section 605, and may be extended to contact, or nearly contact, the land or water below the vessel 10. In this arrangement, which may be referred to as the “open” arrangement, the ladder 600 may be locked to stabilize the second end 608. Further, in one embodiment of the open arrangement of the ladder 600 of the present invention, the ladder 600 may be securely held into a position which is essentially parallel to outer face 203. Alternatively, in a second embodiment of the open arrangement of the present invention, the ladder 600 may be securely held into a position which is not essentially parallel to outer face 203. For example, the ladder 600 may be held, but is not limited to being held, in a position at or near the land or water which is 30 degrees removed away from the outer surface 203 of the vessel 10. It may be preferred to lock the ladder 600 in the open position, for example, when passengers are entering or exiting the vessel 10.

An added benefit of the ladder 600 is that it may be used to rescue an individual in the water when the vessel 10 is in water. In that situation, the ladder may be lowered into the water partially and then locked in that position. Once the ladder 600 is locked in position, a person may step on its rungs and remain on the ladder 600 while also in the water near the individual in need of rescue. The rescuer is therefore in a more stable situation and able to use the ladder 600 for support while aiding the individual. Alternatively, the individual in need of rescue may reach the ladder 600 more easily after it has been lowered into the water and may then pull himself/herself onto the ladder 600.

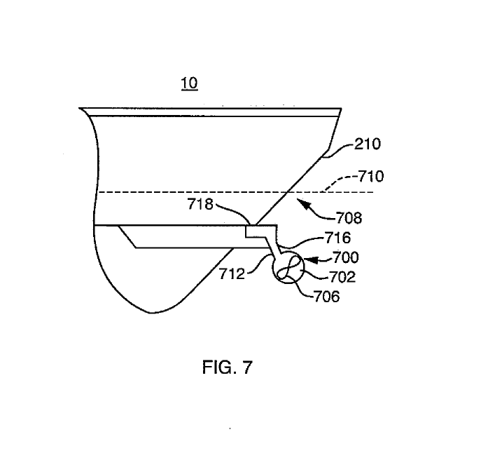

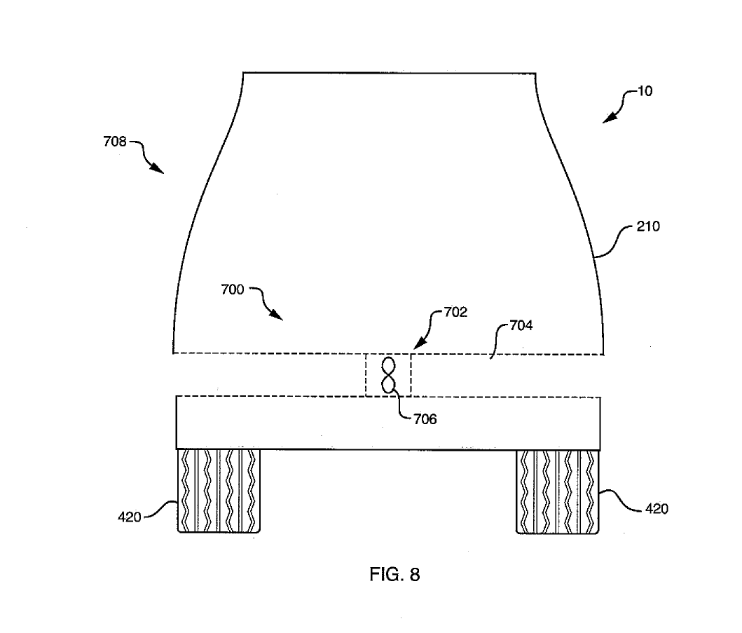

The vessel 10 may further optionally include a bow thruster system 700 as shown in FIGS. 7 and 8. The bow thruster system includes a thruster 702 and a bumper 704. The thruster 702 includes a propulsion component such as impeller 706. The bumper 704 is formed of one or more conduits or pipes extending substantially the entire width of the vessel 10 at bow/front 708 below waterline 710. The bumper 704 is affixed to the hull 210 such as by welding. It may be covered partially or entirely by a resilient material, such as a viscoelastic material. The thruster 702 forms part of, and is substantially aligned with, the bumper 704 at the centerline thereof. The thruster 702 may also be substantially aligned with the centerline of the vessel 10. A thruster conduit 712 extends through a port 714 of the hull 210 and is affixed to the thruster 702. The thruster conduit 712 is also affixed to a control box 716 including electronics and/or power supply arranged to cause movement of the impeller 706. The thruster 702 may be controlled for reversible and variable movement of the impeller 706 by a control component, such as a joystick, accessible by the vessel's pilot.

In one embodiment of the invention, the bumper 704 may be two independent conduits having inside diameter substantially conforming with the inside diameter of the thruster 702. The thruster 702 is preferably first bolted onto and through the hull 210 at the vessel centerline. The two pieces of the bumper 704 are then butted to the thruster 702 and affixed to the exterior of the hull 210. This arrangement establishes a portal through which water may be forced by operation of the thruster 702. The thruster 702 may be hydraulic and plumbed into the relevant existing vessel components as understood by those skilled in the art, or it may be electrical (as shown) and wired into the existing vessel electrical system as understood by those skilled in the art. The thruster 702 may be the same type of bow thruster described hereinabove.

The bow thruster device 700 is arranged to aid in low-speed maneuvering of the vessel 10 while it is in the water, particularly low-speed transverse maneuvering. Specifically, when activated to rotate in a first direction, the impeller 706 causes movement of water through the bumper 704 in a first direction, causing localized opposing movement of the vessel in the opposite direction. Similarly, the impeller 706 may be rotated in a second direction different from the first to cause movement through the bumper 704 in the opposite direction. This results in movement of the vessel 10 in a second direction opposite from the flow of water through the bumper 704.

While the present invention has been described with particular reference to certain embodiments of the amphibious recreational vessel, it is to be understood that it includes all reasonable equivalents thereof as defined by the following appended claims.

What is claimed is:

1. An amphibious recreational vessel having a forward end and an aft end, comprising:
a. an upper section, wherein the upper section includes a plurality of seats and a deck plate;
b. a lower section connected to the upper section at the deck plate such that the separation between the upper section and the lower section is substantially watertight, wherein the lower section forms a hull of the vessel,
c. an engine located within the lower section substantially centered between the forward end and the aft end,
d. a transfer case connected to the engine;
e. a first drive shaft and a second drive shaft connected directly to the transfer case,
f. a first axle connected to the first drive shaft and to a first pair of wheels, wherein the first axle is located forward of the engine and is contained substantially within the hull;
g. a second axle connected to the first drive shaft and to a second pair of wheels wherein the second axle is located aft of the engine, and
h. a marine propulsion unit connected directly to the second drive shaft and located aft of the engine.

2. The vessel of claim 1 wherein the vessel further includes at least one bilge tank.

3. The vessel of claim 1 wherein the vessel further includes exactly two bilge tanks, which are a first bilge tank and a second bilge tank.

4. The vessel of claim 3 wherein the first bilge tank is connected to an inner bottom surface of the hull on the port side of the hull, and the second bilge tank is connected to the inner bottom surface of the hull on the starboard side of the hull.

5. The vessel of claim 4 wherein the transfer case is located between the first bilge tank and the second bilge tank and is connected to the inner bottom surface of the hull.

6. The vessel of claim 5 wherein the engine is located at a position which is between the bilge tanks.

7. The vessel of claim 1 wherein the deck plate includes a watertight hatch for enabling access to the lower section from the upper section.

8. The vessel of claim 1 wherein the hull is substantially watertight.

9. The vessel of claim 1 wherein the marine propulsion unit is a propeller.

10. The vessel of claim 1 wherein the marine propulsion unit is a thruster.

11. The vessel of claim 1 wherein the vessel further includes a means for improved embarking and disembarking of the vessel.

12. The vessel of claim 11 wherein the means for improved embarking and disembarking of the vessel is at least one ladder.

13. The vessel of claim 12 wherein the at least one ladder is spring-loaded.

14. The vessel of claim 1 wherein the vessel further includes at least one high air intake opening and at least one exhaust opening, the at least one high air intake opening and the at least one exhaust opening being located in the lower section.

15. The vessel of claim 14 wherein the at least one high air intake opening is a NACA duct.

16. The vessel of claim 1 further comprising a bow thruster device affixed to the hull, the bow thruster device including a bumper extending along the exterior of the hull at the vessel bow, and a thruster positioned within the bumper.

17. The vessel of claim 16 wherein the thruster is positioned substantially at the centerline of the vessel.
